(19) United States
(12) Patent Application Publication
(10) Pub. No.: US 2008/0312892 A1
(43) Pub. Date: Dec. 18, 2008

(54) Computer-Assisted Method For The Setting Of Particle-Specific Parameters In A Thermal Spray Process

(76) Inventor: Marc Heggemann, Winterthur (CH)

Correspondence Address: ROBERT S. GREEN, SULZER METCO (US), INC., 1101 PROSPECT AVENUE, WESTBURY, NY, 11590, US

(21) Appl. No.: 12/108,005

(22) Filed: Apr. 23, 2008

(30) Foreign Application Priority Data
Apr. 25, 2007 (EP) 07106892.8

(51) Int. Cl. G06G 7/57

(52) U.S. Cl. 703/9

(57) ABSTRACT

A method is disclosed that sets at least one particle-specific parameter in a thermal spray process in which particles are transported by means of a fluid flow from a thermal spray apparatus to a substrate. A first step includes predetermining a target value for the particle-specific parameter, followed by a second step of preparing an operating model for one of the thermal spray process and the thermal spray apparatus with which a simulation of the thermal spray process can be carried out, with the operating model including set values whose variation effects changes in the particle-specific parameter. Next, a third step involves evaluating the operating model for at least one set of starting values for the set values, followed by a fourth step of setting the particle-specific parameter to the target value by an automatic optimisation procedure in which the set values are varied until the target value for the particle-specific parameter results from the operating model.

### CROSS-REFERENCE TO RELATED APPLICATIONS

### Statement Regarding Federally Sponsored Research or Development

Not applicable.

### REFERENCE TO A COMPACT DISK APPENDIX

Not applicable

### BACKGROUND OF THE INVENTION

The invention relates to a computer-assisted method for the setting of at least one particle-specific parameter in a thermal spray process in which particles are transported from a spray apparatus to a substrate by means of a fluid flow.

Thermal spray processes such as plasma spraying are used today for a large variety of coating on very different substrates, for example as corrosion protection coatings or as hard coatings. For this purpose, a light arc is generated between an anode and a cathode in a plasma spray apparatus such as a plasma burner. A gas is ionised between the electrodes such that a plasma is created. The material required for the coating to be generated is usually blown into the hot plasma in powder form, is evaporated or melted there, or is at least made plastic-like or maleable, and is applied to the substrate to be coated by the gas flow at high speed.

Such spray processes are, however, also known in which the process gas is “cold” in comparison with classical plasma spraying, for example at most some hundred degrees Kelvin, so that the particles are not melted in the gas flow and only adhere to the substrate due to their kinetic energy. These processes, known in the literature as cold gas spraying or kinetic gas spraying, as well as hybrid processes (plasma cold gas spraying) should also be included by the term “thermal spraying” within the framework of this application.

Since the coatings to be generated are often of a very different nature, the thermal spray process must usually be adapted to the respective application. In this regard the result to be obtained is often predetermined, such as the deposition rate, the layer thickness, the layer structure or other layer properties such as the porosity, adhesion, surface roughness, electrical conductivity, thermal conductivity, viscosity, wear resistance, portion of unmelted particles or chemical properties such as the degree of oxidation of the layer.

In addition, is it also in particular very important for industrial applications that the spray process per se has a high stability, that it delivers reproducible results, and that it includes a high process and deposition efficiency.

To adapt the thermal spray apparatuses and spray processes to the respective application under these aspects mentioned by way of example, empirical methods are frequently used which are, however, as a rule associated with high costs and a high time effort and moreover require a great deal of experience.

To reduce this effort, mathematical methods have recently also been used with which an attempt is made to simulate the thermal spray process. The methods of numeral flow simulation CFD (computational fluid dynamics) are in particular used for this.

A method is, for example, known from the European patent application No. 07 102 707 (date of application 20 Feb. 2007) for the determination of process parameters in a thermal spray process in which an operating model is set up with which a simulation of the thermal spray process can be carried out. The operating model is preferably based on a flow-mechanical modelling by means of CFD which is coupled with an electromagnetic model which describes the arc or takes account of the electromagnetic effects generated by the arc or by the plasma. A simulation of the thermal spray process at least close to reality is hereby made possible.

Even though this method of simulation of the thermal spray process has proved very successful, there is nevertheless potential for improvements in practice in order to determine conditions or parameters for the thermal spray process and/or the spray apparatus which are as ideal as possible from the properties of the layer to be generated predetermined by the respective application in a manner which is as simple as possible in order to realise just these properties of the layer as accurately as possible. The present invention is directed to this object.

### BRIEF SUMMARY OF THE INVENTION

The method satisfying this object is characterized by the features of independent claim 1.

In accordance with the invention, a computer-assisted method for the setting of at least one particle-specific parameter in a thermal spray process in which particles are transported by means of a fluid flow (G) from a spray apparatus to a substrate (6), the method having the following steps:

predetermining a target value for the particle-specific parameter;

preparing an operating model for one of the thermal spray process or for the thermal spray apparatus with which a simulation of the thermal spray process can be carried out, with the operating model including set values whose variation effects changes in the particle-specific parameter;

evaluating the operating model for at least one set of starting values for the set values;

setting the particle-specific parameter to the target value by an automatic optimisation procedure in which the set values are varied until the target value for the particle-specific parameter results.

In one embodiment of the invention, it is understood that it is specifically the particle-specific parameters such as the particle temperature or the particle speed which have to be set to an application-dependent target value to realise the desired properties of the coating to be generated. In another embodiment the operating model is used for an automated optimisation in which the set values are varied until the target value for the particle-specific parameter or parameters is realised as accurately as possible. Time-consuming model adaptation and iterations carried out step-by-step by hand, whose successful carrying out moreover requires some experience, are no longer required, which signifies a large time saving in practice and permits the use of less qualified personnel instead of highly qualified experts.

The particle-specific parameter or parameters preferably include the energy state of the particles. It has been found that this energy state of the particles, which can be described, for example, by the surface temperature and the speed of the particles, has a very major effect on the properties of the coating to be generated. It is therefore in particular advantageous to determine at least the particle speed and the particle temperature as the particle-specific parameters.

To avoid the automatic optimisation procedure only approaching a local minimum for the target value, it is advantageous to evaluate at least two different sets of starting values for the set values.

In another embodiment the operating model includes the interaction between the particles and the fluid flow. For some applications and/or for the determination of a first approximation, it may well be sufficient to neglect the interaction between the fluid flow and the particles in the operating model; however, they are preferably taken into account.

The method in accordance with the invention can also be used for the improvement or for the optimisation of the geometrical configuration and of the dimensions of the spray apparatus or of their parts. For this purpose, the geometry of the spray apparatus is taken into account as a set value.

It is thus a preferred configuration of the method to optimise the geometry of the spray apparatus to set the particle-specific parameters to the target value.

It is furthermore advantageous for the set values to carry out a sensitivity analysis. It can be recognised how pronouncedly or how sensitively the particle-specific parameter or parameters react to variations in the individual set values. The optimisation process can be accelerated by such a sensitivity analysis.

In a preferred application in which the thermal spray apparatus includes a nozzle through which the fluid flow exits, the operating model is used for the optimisation of the nozzle.

A computer program product is also proposed by the invention for the implementation of a method in accordance with the invention in a data processing system.

Further advantageous measures and preferred embodiments of the invention result from the dependent claims.

### BRIEF DESCRIPTION OF THE DRAWINGS

The invention will be explained in more detail in the following with reference to embodiments and to the drawing. There are shown in the schematic drawing:

FIG. 1 is a schematic representation of an embodiment of a thermal spray apparatus which is configured as a plasma spray apparatus, and

FIG. 2 is a flow chart of an embodiment of a method in accordance with the invention.

### DETAILED DESCRIPTION OF THE INVENTION

A computer-assisted method is proposed by the invention for the setting of at least one particle-specific parameter in a thermal spray process in which particles are transported from a spray apparatus to a substrate by means of a fluid flow, for example a gas flow.

In the majority of applications of thermal spray processes in which a coating is applied to a substrate, the type of coating to be generated is predetermined, for example whether it is a corrosion protection coating or a thermal protection coating or a hard coating or an abradable coating. The thermal spray process must now be carried out such that the predetermined properties of the layer are realised in as ideal a manner as possible, with the spray process moreover being carried out rationally and efficiently. An important aspect for the invention is the recognition that it is important for the realisation of the predetermined layer properties to set the particle-specific parameters, and particularly the energy state of the particles, to the correct value.

Reference is made in the following to the application particularly important for practice that the thermal spray process is a plasma spray process and the spray apparatus is a plasma spray apparatus. The invention is naturally not restricted to such applications, but is also suitable for other thermal spray processes such as radio frequency (RF) plasma spraying or arc wire spraying. The invention is also suitable for cold gas spray processes or kinetic gas spray processes as well as hybrid plasma cold gas spray processes. All these processes and similar processes are to be meant by the term “thermal spray processes” within the framework of this application.

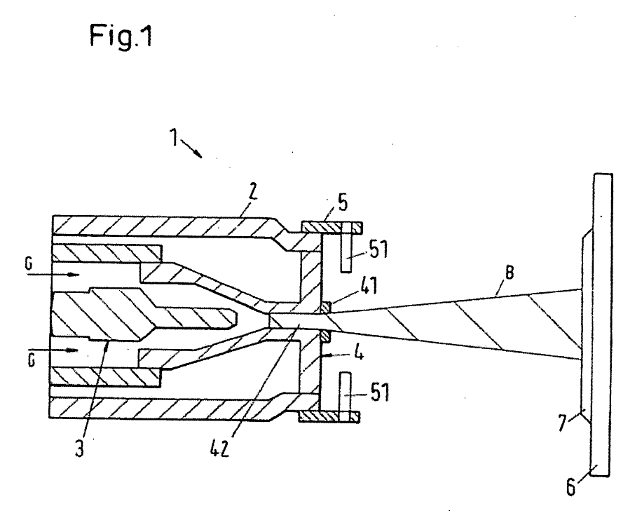

FIG. 1 shows a schematic representation of an embodiment of a plasma spray apparatus 1. The plasma spray apparatus 1 includes a housing 2 in which a cathode arrangement 3 and an anode 4 electrically insulated thereagainst is provided. The anode 4 is configured as a ring anode which has an outlet opening 42 at its centre which is provided with a nozzle 41. During operation, a gas is blown through the plasma spray apparatus 1 in the axial direction as is indicated by the two arrows designated by the reference symbol G. A powder feed 5 is provided behind the ring-shaped anode 4 in the direction of flow and has one or more feed passages 51 which extend substantially in the radial direction. It is naturally also possible that the feed passages 51 for the powder or the particles extend in the axial direction or obliquely—that is between the axial direction and the radial direction—or also in the tangential direction.

The representation of further components of the plasma spray apparatus 1 such as the cooling, energy supply and control devices has been omitted for reasons of better clarity.

The plasma spray device 1 can in particular also be a multicathode burner such as the burner which is marketed under the trade name TriplexPro by the applicant. With this burner, the cathode arrangement 3 includes a total of three cathodes. Three arcs are then created in the operating state.

During operation, the gas G flowing through the plasma spray apparatus 1 in the axial direction is ionised and at least one arc is generated between the cathode arrangement 3 and the anode 4. The gas G heated by the plasma passes through the nozzle 41 and out of the anode at high speed and at a high temperature. Particles in the form of a powder are blown into the hot gas flow directly behind the anode 4 (viewed in the direction of flow) through the feed passages 51 of the powder feed 5. The particles are melted in the gas flow or are at least made plastic, are accelerated by the gas flow and are hurled onto a substrate 6 where they form a coating 7. The gas flow charged with the particles is shown schematically in FIG. 1 as a coating jet B.

It is frequently the case in application that the result to be obtained—that is the coating 7 on the substrate 6 or its properties—are predetermined and the thermal spray process is to be set such that the desired result can be realised as accurately, as efficiently, as cost-favourably and as reproducibly as possible. It is in particular important for this purpose to set the particle-specific parameters to a value suitable for the application.

“Particle-specific parameters” are to mean all the parameters which describe the properties of the particles or of the particle flow in the spray process; and include (in a non-exclusive list): speed and speed distribution of the particles; temperature and/or surface temperature of the particles; energy state of the particles; distribution of the energy state of the particles; size and shape of the particles; ductility of the particles; aggregate state of the particles; thermal content of the particles; trace of the particles; mass flow of the particles; ratio of mass flow of the particles to the mass flow of the gas.

The method in accordance with the invention is not limited to only setting precisely one particle-specific parameter. It is also possible and can also be advantageous for two or more parameters to be used.

In the following, reference is made to the preferred embodiment that the energy state of the particles is used as the particle-specific parameter. In this embodiment, the energy state of the particles is specifically described by the surface temperature of the particles and the speed of the particles. In this context, the surface temperature serves as a measure for the internal thermal energy and thus the thermal state of the particles (e.g. whether they have already started to melt or have melted) and the speed serves as the measure for the kinetic energy of the particles. The temperature and speed of the particles usually means the temperature and the speed upon impact on the substrate.

The properties of the layer to be generated should be illustrated at least qualitatively with reference to some examples.

For example, if one wants to generate hard and compact layers, the particles must have a high kinetic energy, that is a speed which is as large as possible, and the particle temperature should be set such that the particles are located just at or a little below the melting point of the powder material. The particles then melt on impact onto the substrate and immediately freeze out (that is become solid again) there. The high kinetic energy caused by the high particle speed compacts the deposited layer and thereby makes it very hard. The kinetic energy should not be so high that the impacting particles knock out material already deposited from the layer or knock out material from the substrate.

To generate a porous ceramic structure as a layer on the substrate, the thermal energy, i.e. the temperature of the particles, is to be set such that the particles are well above the melting temperature and well below the evaporation temperature. The particles have sufficient time to recrystallise after their deposition on the substrate thanks to this measure. The kinetic energy of the particles, i.e. their speed, is set such that it is as low as possible. The particles only have to have sufficient speed to reach the substrate and to form the layer.

It is particularly advantageous to use cold gas spray processes having process gas temperatures of a maximum of some hundreds of degrees for the manufacture of a high temperature alloy whose properties are as close as possible to those of a forged layer. The particle temperature is to be set such that the particles are just ductile, but so low that phase conversions or chemical reactions cannot occur. The particle speed is selected to be very high so that a deposition takes place at all and to ensure that a compacting of the layer to a dense structure takes place. For this purpose, particles speeds of more than 1000 m/s can be realised—preferably in two-stage kinetic gas spray apparatuses.

These examples illustrate that it is important for the realisation of the desired layer properties to set one or more particle-specific parameters to a presettable target value.

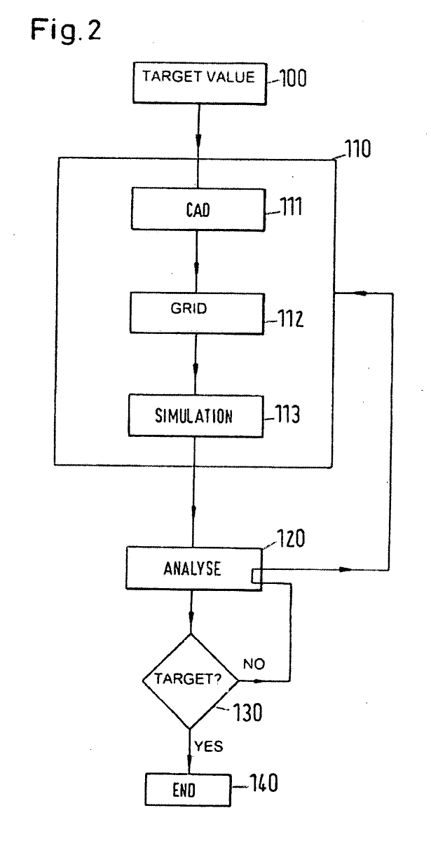

It will now be described how this can be done with an embodiment of the computer-assisted method in accordance with the invention which is shown schematically as a flow chart in FIG. 2.

First, the particle-specific parameters are fixed which should be set by the method, that is for example the particle temperature and the particle speed. It is also possible only to preset one particle-specific parameter. Then, a target value is preset for each particle-specific parameter to be set in step 100. This target value can be determined, for example, based on empirical data, from experience values, by technical considerations, by estimates or also by measurements. Using particle diagnosis systems known today such as the TECNAR DPV-2000, it is possible to determine particle speed and the temperature or the surface temperature of the particles in the thermal spray process.

The target value can in each case be either an individual value or a range of values. In the latter case, a lower limit and an upper limit for the particle-specific parameter to be set will be predetermined as the target value, e.g. that the particle speed must be greater than a first value and smaller than a second value. In particular when adjusting a plurality of particle-specific parameters, it is preferable to give the target value predetermine ranges. It is also possible to predetermine characteristic parameters of a distribution as the target value, for example the standard deviation of the velocity distribution of the particles.

After a target value has been predetermined for each particle-specific parameter, an operating model 110 is set up for the thermal spray process or for the thermal spray apparatus. There are naturally a number of possibilities for this. It is important that a simulation of the thermal spray process can be carried out with the selected operating model, with the operating model including set values whose variation effects changes in the particle-specific parameter or parameters.

Set values means all adjustable parameters with which the spray process can be influenced. The set values can roughly be divided into two groups, namely the set values which determine the geometry of the spray apparatus and the set values which define the process.

The first group includes, for example, the discharge surface of the nozzle or nozzles, the position of the nozzle, its length, the geometrical design of the nozzle rim, the length and the curvature of the diverging part of the nozzle, in the case of laval-type nozzles the length and the curvature of the converging nozzle part, the geometry and the orientation of the feed passages 51 (FIG. 1) for the powder, etc.

The second group includes, for example, the type of spray process (plasma, cold gas, wire spray, HVOF, etc.), the morphology of the powder (particle size and particle shape, aggregate state), type and flow rates of the gases used in the process, supply rate of the powder, ratio of powder supply rate to the gas flow rate, process atmosphere (normal pressure, underpressure, vacuum, gas atmosphere), flow, voltage, gas pressure, etc.

A number of these set values, for example the atmosphere in which the spray process is carried out or the type of spray process, are already generally predetermined by the type of the layer to be generated and are therefore fixed in the operating model 110. There are, however, still sufficient set values which so-to-say serve as “adjustment screws” in the operating model 110 to set the particle-specific parameters to the predetermined target value.

It is advantageous if a sensitivity analysis is carried out with reference to considerations or simulations or other calculations for those individual set values which are not fixed in the operating model, but are variable, in order to find out how sensitively the particle-specific parameters react to changes in the individual set values.

The operating model 110 is preferably a CFD model (computational fluid dynamics model), that is it is based on a numerical flow simulation. Specifically for plasma processes and other arc spray processes, the operating model is particularly preferably a CFD model which is coupled to an electromagnetic model. Such a modelling is, for example, described in detail in the already mentioned European patent application No. 07 102 707.2 of Sulzer Metco AG whose content is herewith incorporated by reference. It is therefore not necessary to look more closely at this type of modelling within the framework of the present application.

The CFD method has developed into a very efficient tool for the examination of flows in the past few years. The CFD and its principles per se are known to the person of average skill in the art and therefore do not have to be explained in more detail here.

The three fundamental principles of the conservation of mass, momentum and energy apply to each flow. The physical relationships and equations (the Navier-Stokes equations) resulting from this are, however, in their general form, no longer analytically soluble. It is the object of the CFD to determine numerical solutions for such equations to describe a flow field as realistically as possible. The Navier-Stokes equations contain the variables describing the flow such as the speed, pressure, density, viscosity and temperature as a function of location and time.

Within the framework of this application, CFD is understood as a method of calculating both the frictionless flows and the friction-charged flows of uniphase or multiphase fluids (continuous phase), optionally while simultaneously taking account of the movement of liquid drops or solid particles (disperse phase). The fluids can be compressible or incompressible. The interaction or interdependency of the continuous phase with the disperse phase can be described both with the Lagrange-Euler model and with the Euler-Euler model. The exchange of mass, momentum and energy can be observed either in one direction (from the continuous to the discrete phase or one-way coupling, or vice versa) or in both directions (complete coupling or two-way coupling).

Both CFD methods are meant in which the disperse phase is included in the model as well as CFD methods in which the disperse phase is not included in the model. This means that the particles do not necessarily have to be taken into account in the model. The operating model, however, preferably also includes the particles and the interaction between the particles and the gas flow.

Both the continuous phase and the discrete phase can each include a plurality of components (multi-component phase). For example, in plasma spraying, a mixture of argon and helium can be used; then the continuous gas phase includes the two components argon and helium. The discrete phase can also include a plurality of components when, for example, a powder mixture of different substances is used as the particles in the plasma spraying or when already melted and still solid particles form two components of the discrete phase.

There are a number of computer program products and algorithms known per se and commercially available for CFD which are sufficiently known to the person of average skill in the art so that they are not looked at further here.

In the present embodiment, the CFD operating model 110 for the simulation of the spray process, which can be coupled with an electromagnetic model based on the Maxwell equations in dependence on the type of spray process, includes a plurality of modules. In the module 111, the flow space to be calculated is first defined as a three-dimensional volume body, for example a parametric CAD model is prepared. In this connection, it is optionally possible not to detect the total flow space, but to utilise symmetries and to limit the calculations to a part space, for example to a third of the flow space. The grid is generated in the module 112. For this purpose, small finite sub-volumes are defined into which the volume body is divided. These sub-volumes form the numerical computational grid. The marginal conditions are fixed which define the physical operating conditions, for example mass flows or flow rate at entry, temperature of the gas on entry, temperature at the walls, current strength or similar.

The simulation of the spray process takes place in the module 113. For this purpose, starting values are used for the variable set values and the flow parameters such as pressure, speed or temperature are determined in each sub-volume via numerical procedures known per se. The results lead to a three-dimensional flow field which is then evaluated quantitatively and qualitatively in order thus to obtain values for the particle-specific parameters to be set.

These values are then evaluated in an analysis model 120, with a check in particular being made in step 130 whether the target value or target values is realised or are realised.

If so, the particle-specific parameters are set to the predetermined target values and the method ends at step 140.

If no, an automatic optimising procedure takes place. For this purpose, changes are determined for the set values in the analysis module 120 based on the analysis carried out and these amended set values are fed into the operating model 110 to calculate a new simulation. This procedure is repeated for so long until all particle-specific parameters are set to their respective target value.

The analysis model which carries out the changes to the set values for their optimisation has access to all the modules of the operating model 110 in this connection. It can thus in particular also cause changes in the design of the spray apparatus, i.e. in the geometrical configuration, namely in that it accesses the module 111 with the parametric CAD model and makes changes there.

In accordance with the invention, the optimisation process takes place automatically for the setting of the particle-specific parameters to the respective target value.

Computer program products are known with which such automatic optimisation procedures can be carried out. The product modeFRONTIER of the company Esteco can be named with exemplary character here which is suitable for integration into the method in accordance with the invention. Since the automatic optimisation is known per se to the skilled person, it is not explained in more detail here.

An advantageous measure consists of evaluating at least two, and preferably ten, different sets of starting values for the variable set values. It can namely hereby be precluded with an at least high probability that the optimisation procedure results in a local minimum or maximum.

The computer-assisted method in accordance with the invention is in particular also suitable to optimise the design, i.e. the specific geometrical configuration of the spray apparatus or parts thereof, such as the nozzle 41.

Since the total thermal spray process can be simulated by the operating model, and since moreover an automatic optimisation takes place, it becomes possible to adapt the thermal spray apparatus substantially faster and more effectively to the respective application or to optimise it for the respective application. This is in particular an important advantage with respect to the new development and further development of thermal spray apparatuses or parts thereof. No time-intensive and cost-intensive series of trials are namely necessary any more for the adaptation and optimisation in which empirically motivated modifications are tested, but the influence of changes on the particle-specific parameters can be examined with reference to the operating model without any experimental effort.

The simplicity and speed effected by the automatic optimisation by means of simulation is in particular also of great advantage in the configuration of new nozzles specific to an application. In particular laval-type nozzles with a converging part and a diverging part can thus also be optimised better and faster for the acceleration of the gas to supersonic speed.

For some applications it is advantageous with respect to the optimisation when at least two parameters are selected as the particle-specific parameters to be set which cannot be accurately optimised simultaneously, which consequently are so incompatible with one another that, from a specific point onwards, an improvement with respect to the one parameter necessarily results in a deterioration of the other parameter. In such cases, no clear optimisation is possible; a Pareto optimisation is then carried out whose result is a Pareto front. It is accordingly a specific application example that the one particle-specific parameter is the particle speed and the other particle-specific parameter is the ratio of the mass flow of the particles to the mass flow of the gas.

The automatic optimisation in accordance with the invention can in particular be combined very easily with the methods which are disclosed or claimed in the already mentioned European patent application No. 07 102 707.2 of Sulzer Metco AG.

The method in accordance with the invention is preferably implemented in the form of a computer program product in a data processing system.

1. A computer-assisted method for the setting of at least one particle-specific parameter in a thermal spray process in which particles are transported by means of a fluid flow from a spray apparatus to a substrate, said method including the following steps:
predetermining a target value for the particle-specific parameter,
preparing an operating model for the thermal spray process or for the thermal spray apparatus with which a simulation of the thermal spray process can be carried out, with the operating model including set values whose variation effects changes in the particle-specific parameter;
evaluating the operating model for at least one set of starting values for the set values;
setting the particle-specific parameter to the target value by an automatic optimisation procedure in which the set values are varied for so long until the target value for the particle-specific parameter results from the operating model.

2. A method in accordance with claim 1, wherein the at least one particle-specific parameter includes the energy state of the particles.

3. A method in accordance with claim 1, wherein at least the particle speed and the particle temperature are determined as particle-specific parameters.

4. A method in accordance with claim 1, wherein at least two different sets of starting values are evaluated for the set values.

5. A method in accordance with claim 1, wherein the operating model includes the interaction between the particles and the fluid flow.

6. A method in accordance with claim 1, wherein the geometry of the spray apparatus is taken into account as a set value.

7. A method in accordance with claim 1, wherein the geometry of the spray apparatus is optimised to set the particle-specific parameter to the target value.

8. A method in accordance with claim 1, wherein a sensitivity analysis is carried out for the set values.

9. A method in accordance with claim 1, wherein the thermal spray device includes a nozzle through which the fluid flow exits, with the operating model being used for the optimisation of the nozzle.

10. A computer program product for the implementation of a method in accordance with claim 1 in a data processing system.

11. A method for setting at least one particle-specific parameter in a thermal spray process in which particles are transported by means of a fluid flow from a thermal spray apparatus to a substrate, the method comprising the following steps:
a first step of predetermining a target value for the particle-specific parameter;
a second step of preparing an operating model for one of the thermal spray process and the thermal spray apparatus with which a simulation of the thermal spray process can be carried out, with the operating model including set values whose variation effects changes in the particle-specific parameter;
a third step of evaluating the operating model for at least one set of starting values for the set values;
a fourth step of setting the particle-specific parameter to the target value by an automatic optimisation procedure in which the set values are varied until the target value for the particle-specific parameter results from the operating model.

12. The method of claim 11, wherein the at least one particle-specific parameter includes the energy state of the particles.

13. The method of claim 11, wherein at least the particle speed and the particle temperature are determined as particle-specific parameters.

14. The method of claim 11, wherein at least two different sets of starting values are evaluated for the set values.

15. The method of claim 11, wherein the operating model includes the interaction between the particles and the fluid flow.

16. The method of claim 11, wherein the geometry of the spray apparatus is taken into account as a set value.

17. The method of claim 11, wherein the geometry of the spray apparatus is optimised to set the particle-specific parameter to the target value.

18. The method of claim 11, wherein a sensitivity analysis is carried out for the set values.

19. The method of claim 11, wherein the thermal spray device includes a nozzle through which the fluid flow exits, with the operating model being used for the optimisation of the nozzle.

20. A computer program that sets at least one particle-specific parameter in a thermal spray process in which particles are transported by means of a fluid flow from a thermal spray apparatus to a substrate, the program comprising:
receiving a predetermined target value for the particle-specific parameter;
preparing an operating model for one of the thermal spray process and the thermal spray apparatus with which a simulation of the thermal spray process can be carried out, with the operating model including set values whose variation effects changes in the particle-specific parameter;
evaluating the operating model for at least one set of starting values for the set values; and
setting the particle-specific parameter to the target value by an automatic optimisation procedure in which the set values are varied until the target value for the particle-specific parameter results from the operating model.
